(19) United States
(12) Patent Application Publication
(10) Pub. No.: US 2010/0254416 A1
(43) Pub. Date: Oct. 7, 2010

(54) TUNABLE LASER SOURCE AND LINEWIDTH NARROWING METHOD

(76) Inventor: Kouichi Suzuki, Tokyo (JP)

Correspondence Address: Mr. Jackson Chen, 6535 N. STATE HWY 161, IRVING, TX, 75039, US

(21) Appl. No.: 12/752,233

(22) Filed: Apr. 1, 2010

(30) Foreign Application Priority Data
Apr. 1, 2009 (JP) 2009-089451

(51) Int. Cl. H01S 3/13; H01S 3/10

(52) U.S. Cl. 372/20; 372/32; 372/34

(57) ABSTRACT

A tunable laser source includes a resonator filter which includes a multiple optical resonator having a plurality of optical resonators different in optical path length, an optical amplifier which amplifies output light from the resonator filter, a temperature control element provided for the resonator filter, an optical output level detection unit which detects an output level of light output from the optical amplifier, and a temperature control unit which controls the state of the temperature control element so as to maximize the output level detected by the optical output level detection unit.

This application is based upon and claims the benefit of priority from Japanese patent application No. 2009-089451, filed on Apr. 1, 2009, the disclosure of which is incorporated herein in its entirety by reference.

### TECHNICAL FIELD

The present invention relates to a tunable laser source, which is used in a large-capacity optical transmission system or the like and is capable of oscillating light of a plurality of wavelengths, and a linewidth narrowing method therefor.

### BACKGROUND ART

A light source (tunable laser source [TLS]) whose oscillation wavelength is variable has been used in a wavelength division multiplexing (WDM) communication system which multiplexes and transmits a plurality of optical signals having different wavelengths or in a dense wavelength division multiplexing (DWDM), which is high-density WDM, communication system.

Referring to FIG. 1, there is shown a plan view illustrating a tunable laser source described in Japanese Patent Application Publication JP-P2008-60445A. The tunable laser source shown in FIG. 1 has a semiconductor optical amplifier (SOA) 101, which includes a gain region 111 and a phase control region 112, and a ring resonator filter 102. The ring resonator filter 102 is formed on a planar lightwave circuit (PLC) board.

The ring resonator filter 102 includes a multiple optical resonator 110, which is composed of a plurality of ring resonators 103A, 103B, and 103C slightly different in optical path length, and Thermo-Optic (TO) phase shifters 104A and 104B, which are disposed in the ring resonators 103A and 103B and function as heaters respectively. The ring resonators 103A, 103B, and 103C in the multiple optical resonator 110 are connected via optical waveguides 106 and 107.

In the ring resonator filter 102, the ring resonator 103A is connected to a reflection-side optical waveguide 105 with high-reflection coating 109 applied thereto at one end. Moreover, the ring resonator 103C is connected to an input/output side optical waveguide 108 on the side of inputting and outputting light.

In the ring-shaped waveguides made of glass or compound semiconductor in the ring resonators 103A and 103B, the refractive index of the glass or the compound semiconductor change according to a temperature change. The TO phase shifters 104A and 104B are tunable devices which apply heat to the ring-shaped waveguides in the ring resonators 103A and 103B, respectively, to change the refractive indices of the ring-shaped waveguides independently of each other and which thereby change the optical path lengths of the ring resonators 103A and 103B, respectively, to change the resonance wavelength of the multiple optical resonator 110.

If electric current is injected into the gain region 111 in the SOA 101, a gain for oscillation is obtained.

The phase control region 112 is made of compound semiconductor or the like which changes in refractive index according to the injected electric current. The electric current, which is injected into the phase control region 112, is adjusted in order to control the optical phase so as to achieve optimum oscillation characteristics. More specifically, the semiconductor material is designed to have an energy band gap (energy of electrons and carriers determined by compound semiconductor material) corresponding to a light wavelength shorter than the light wavelength of the ring resonator filter 102 as a continuous wave (CW) light source.

Moreover, since the TO phase shifters 104A and 104B apply heat to the ring resonators 103A and 103B in order to control an output light wavelength (oscillation wavelength), the temperature of the PLC board changes. Since the oscillation characteristics change upon the change in the temperature of the PLC board, control is performed to stabilize the temperature of the PLC board (for example, refer to Japanese Patent Application Publication JP-P2008-193003A). In general, the temperature of the PLC board is controlled to an accuracy of 0.01 to 0.1° C. In order to control the temperature of the PLC board, for example, a Peltier device is attached to the PLC board. Then, a thermistor is disposed on the PLC board and the Peltier device is controlled so as to stabilize the temperature of the PLC board detected through the thermistor.

In the DWDM communication system, the number of WDM wavelength channels is increased or a transmission rate per channel is increased to implement a large-capacity transmission. Setting the transmission rate per channel to 10 Gbps or higher, however, restricts on the transmission distance of an optical signal because of influence of chromatic dispersion or polarization mode dispersion.

An optical transmission system having a transmission rate of 40 Gbps or higher is being put to practical use. In an optical transmission system having a transmission rate in the order of 10 Gbps, there is widely used an intensity modulation for transmitting information according to a change between ON (emission state) and OFF (extinction state) states of an optical signal (amplitude shift keying). In the optical transmission system having a transmission rate of 40 Gbps or higher per channel, there is used a phase modulation such as differential phase shift keying (DPSK) or differential quadrature phase shift keying (DQPSK) with a view to extending the transmission distance of the optical signal or the like. To use these phase modulations, a narrow-linewidth tunable laser source with a narrow light-source spectral linewidth is required. Further, the linewidth of the CW light source with a general distributed feedback laser diode (DFB-LD) almost exceeds 10 MHz.

While it is necessary to control phase information in order to increase the frequency usage efficiency in the case of using the phase modulation, frequency fluctuations of the CW light source corresponding to carriers are not able to be reduced or corrected in the phase modulation, and therefore a wide linewidth causes a limitation on transmission. Therefore, it is required to achieve a CW light source having smaller frequency fluctuations (under 1 MHz).

In a tunable laser source made by the SOA 101 which includes the gain region 111 and the phase control region 112, and adapted to optimize the resonant mode by controlling the phase control region 112, the linewidth is apt to increase since the phase control region 112 is sensitive to current variation. For example, the sensitivity is in the order of Δf/Δl=0.1 to 1 (MHz/μA), in case the sensitivity is represented by a ratio of frequency fluctuation to injected current fluctuation. If current noise in the order of 10 μA is generated from a circuit or the like and the current noise enters the SOA 101, random noise in the order of 1 MHz to 10 MHz is added to the linewidth. The current noise in the order of 10 μA is easily generated due to shot noise or thermal noise of an operational amplifier or the like in an optical transmitter or the like.

A linewidth in the order of 10 MHz does not cause a problem on optical transmission in an optical transmission system operating at a transmission rate per channel in the order of 10 Gbps. However, a linewidth in the order of 10 MHz has influence such as deterioration on the transmission characteristics in an optical transmission system operating at a transmission rate per channel of 40 Gbps or more.

In Japanese Patent Application Publication JP-2008-60445A, a tunable laser source, which is a piezoelectric element disposed in the input/output side optical waveguide 108 shown in FIG. 1 and uses a SOA not including a phase control region, is described. Further, the tunable laser source controls the stress applied to the input/output side optical waveguide 108 by the piezoelectric element in order to optimize the resonant mode. According to the structure, it is necessary to mount an additional component on a ring resonator filter, while no linewidth variation is caused by variation of the electric current injected into the phase control region.

### SUMMARY OF THE INVENTION

An exemplary object of the present invention is to provide a tunable laser source capable of narrowing the linewidth of an output light without any special additional components and a linewidth narrowing method.

According to an exemplary aspect of the invention, a tunable laser source comprising a resonator filter which includes a multiple optical resonator having a plurality of optical resonators different in optical path length, an optical amplifier which amplifies output light from the resonator filter, and a temperature control element provided for the resonator filter, the tunable laser source including: an optical output level detection unit which detects an output level of light output from the optical amplifier; and a temperature control unit which controls the state of the temperature control element so as to maximize the output level detected by the optical output level detection unit.

According to an exemplary aspect of the invention, a linewidth narrowing method for narrowing a linewidth of optical output emitted from a tunable laser source comprising a resonator filter which includes a multiple optical resonator having a plurality of optical resonators different in optical path length, an optical amplifier which amplifies output light from the resonator filter, and a temperature control element provided for the resonator filter, the linewidth narrowing method comprising the steps of: detecting an output level of light output from the optical amplifier, and controlling the state of the temperature control element so as to maximize the detected output level.

### BRIEF DESCRIPTION OF THE DRAWINGS

FIG. 1 is a plan view illustrating a tunable laser source related to the present invention.

FIG. 2A is a plan view illustrating a first exemplary embodiment of the tunable laser source according to the present invention.

FIG. 2B is a sectional view illustrating the first exemplary embodiment of the tunable laser source according to the present invention.

FIG. 3 is a flowchart illustrating the operation of a control unit in the first exemplary embodiment.

FIG. 4 is an explanatory diagram illustrating a result of measurements of a linewidth in an optical output from a SOA having a phase control region and a linewidth in an optical output from a SOA of the exemplary embodiment.

FIG. 5 is a plan view illustrating a second exemplary embodiment of the tunable laser source according to the present invention.

FIG. 6 is a flowchart illustrating the operation of a control unit in the second exemplary embodiment.

FIG. 7 is a block diagram illustrating a main part of the tunable laser source according to the present invention.

### DESCRIPTION OF THE EXEMPLARY EMBODIMENT

The substance of the present invention will be described first. Since an optical transmission system is more susceptible to chromatic dispersion along with an increase in transmission rate (for example, 40 Gbps or higher and further up to 100 Gbps), coherent transmission for phase-modulating the main signal is considered as described above. To achieve the coherent transmission, a light source with a narrow linewidth is required. A light source with a wide linewidth emits light having a random frequency fluctuation and therefore the frequency fluctuation is converted to phase noise during optical fiber transmission, thereby disabling satisfactory transmission characteristics to be achieved.

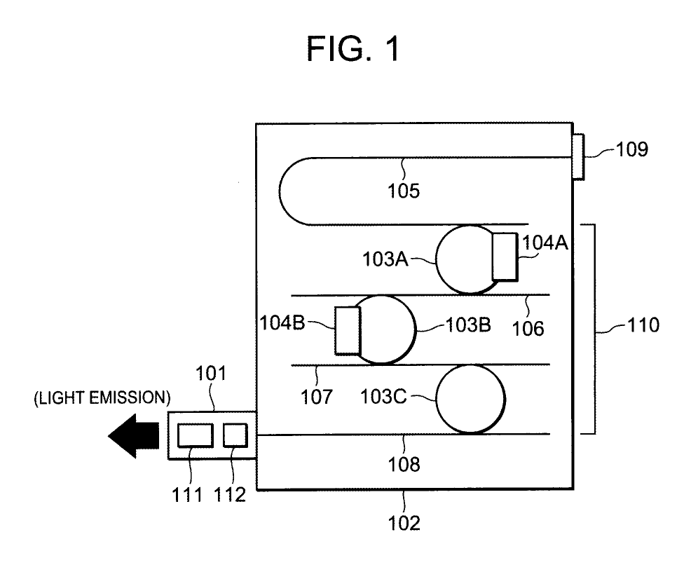

To achieve the light source with a narrow linewidth, it is advantageous to use an external resonator structure, such as a ring resonator as shown in FIG. 1, capable of having a long resonant length. The tunable laser source of the ring resonant type shown in FIG. 1 has controlled a refractive index of the phase control region by controlling the electric current injected into the phase control region of the SOA in order to optimize the oscillation mode. In the structure of controlling the phase control region of the SOA, however, the linewidth tends to increase due to an effect of current noise.

However, if the electric current of 10 mA, 1 mA, or 1 μA is injected into the phase control region of the SOA, the linewidth is 4 GHz, 400 MHz, or 400 kHz, respectively, for example. It is because a refractive index variation to the electric current injected into the phase region of the SOA is nonlinear and the refractive index variation decreases along with an increase in the injected electric current. More specifically, the smaller the electric current injected into the phase control region is, the more the linewidth increases. Therefore, the linewidth is able to be more effectively narrowed by optimizing the oscillation mode through other controls, instead of controlling the phase control region of the SOA.

Therefore, in the tunable laser source according to the present invention, the oscillation mode is in the optimum conditions by controlling the temperature of the PLC board, instead of controlling the phase control region of the SOA. In addition, the oscillation mode is in the optimum conditions without additional components. The oscillation mode is in the optimum conditions, while the maximum optical output emitted from the SOA to the outside. Therefore, according to the present invention, the temperature of the PLC board is controlled in such a way as to maintain the maximum optical output while monitoring the optical output from the SOA.

Hereinafter, the exemplary embodiments of the present invention will be described in detail with reference to the accompanying drawings.

### Exemplary Embodiment 1

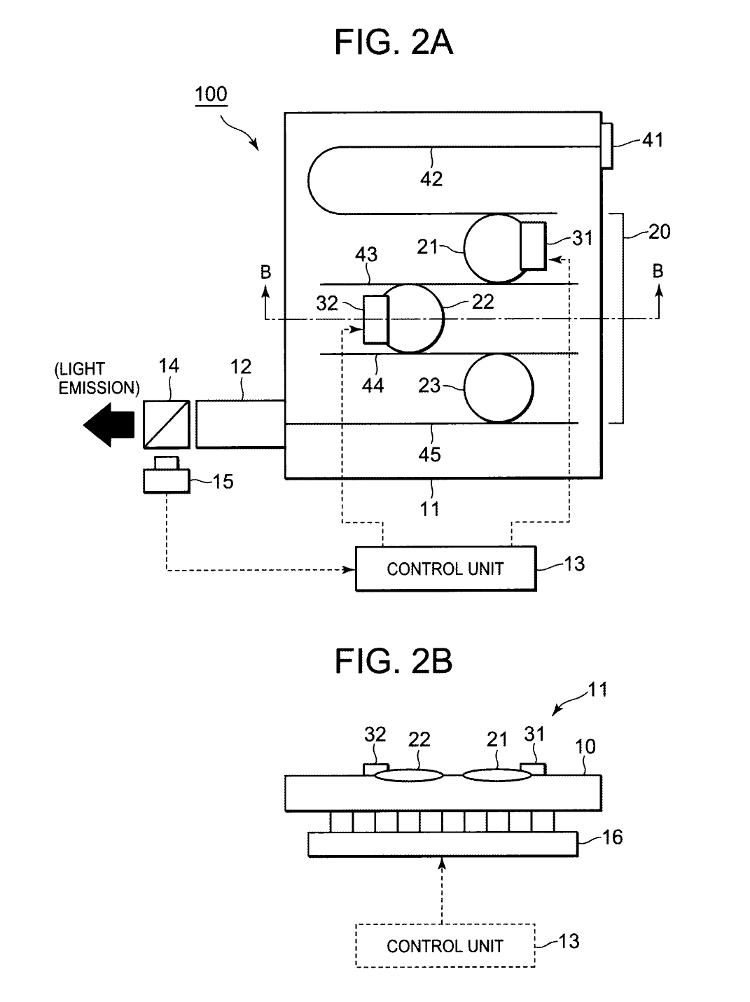

Referring to FIG. 2A, there is shown a plan view illustrating a first exemplary embodiment of a tunable laser source according to the present invention. Referring to FIG. 2B, there is shown a sectional view schematically illustrating the tunable laser source shown in FIG. 2A, taken along the line B-B thereof.

As shown in FIGS. 2A and 2B, a tunable laser source 100 has a ring resonator filter 11 and a SOA 12 including a gain region for amplifying an optical signal.

The ring resonator filter 11 includes a multiple optical resonator 20 composed of three ring resonators 21, 22, and 23 slightly different in optical path length and TO phase shifters 31 and 32 which are disposed on the ring resonators 21 and 22, respectively, and function as heaters. The ring resonators 21, 22, and 23 in the multiple optical resonator 20 are connected to each other via optical waveguides 43 and 44.

In the ring resonator filter 11, the ring resonator 21 is connected to a reflection-side optical waveguide 42 with high-reflection coating 41 applied thereto at one end. Moreover, the ring resonator 23 is connected to an input/output side optical waveguide 45 on the side of inputting and outputting light.

In the multiple optical resonator 20, the ring resonator 21 corresponds to a resonator for coarse turning and the ring resonator 22 corresponds to a resonator for fine tuning. The ring resonator 23 corresponds to a resonator for fixing an oscillation wavelength.

The ring resonator filter 11 is formed on a PLC board 10. On the PLC board 10, the ring resonators 21, 22, and 23, the reflection-side optical waveguide 42, the optical waveguides 43 and 44, and the input/output side optical waveguide 45 are formed by, for example, a silica-based glass waveguide made of silica-based glass deposited on a silicon substrate or a glass substrate.

The TO phase shifters 31 and 32 are formed as film-like heaters made of, for example, aluminum films evaporated in the positions corresponding to the ring resonators 21 and 22 in the ring resonator filter 11, respectively. The TO phase shifters 31 and 32 control the optical path lengths of the ring resonators 21 and 22 using the thermo-optical effect.

More specifically, a control unit 13 controls electric power supplied to the TO phase shifters 31 and 32. In the ring-shaped waveguides made of glass and compound semiconductor in the ring resonators 21 and 22, the refractive index of the glass and that of the compound semiconductor change according to a temperature change. The control unit 13 applies heat depending on a desired oscillation wavelength to the ring-shaped waveguides of the ring resonators 21 and 22 by controlling the electric power supplied to the TO phase shifters 31 and 32. The applied heat changes the refractive indices of the ring-shaped waveguides independently of each other. In response to the changes in the refractive indices, changes occur in the optical path lengths of the ring resonators 21 and 22 and in the resonance wavelength of the multiple optical resonator 20.

Moreover, the control unit 13 generates a gain for oscillation by controlling the electric current injected into the SOA 12.

As shown in FIG. 2B, a Peltier device 16, which is a preferable example of a temperature control element, is attached to the PLC board 10.

Further, on the optical output side of the SOA 12, there are disposed a prism coupler 14, as a light ejecting unit for emitting light whose light quantity is in the order of one tenth of the incident light in a light emitting direction changed by 90°, and a light receiving element 15 for detecting the level of the light emitted from the prism coupler 14. The light receiving element 15 is, for example, a photodiode which functions as a photoelectric conversion element. A signal corresponding to the level detected by the light receiving element 15 is input to the control unit 13.

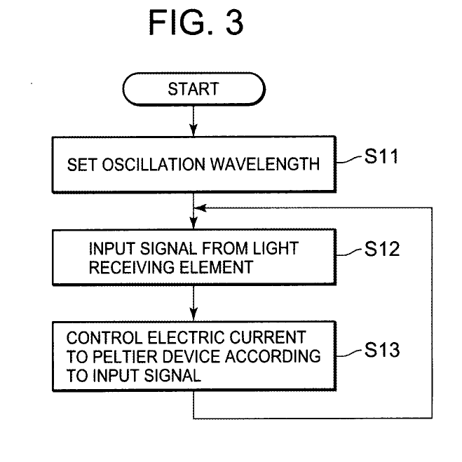

Subsequently, the operation of the control unit 13 will be described with reference to a flowchart shown in FIG. 3. The control unit 13 controls electric power supplied to the TO phase shifters 31 and 32 so as to emit light having a desired wavelength from the tunable laser source 100 (step S11) and then receives the signal from the light receiving element 15 (step S12). Thereafter, the control unit 13 increases or decreases electric power (more specifically, electric current or voltage or both) to the Peltier device 16 according to the optical output level indicated by the signal from the light receiving element 15 (step S13). The control unit 13 changes the polarity of the electric current, if necessary.

For example, if the signal input from the light receiving element 15 at a plurality of timings indicates an increasing tendency of the optical output level, the control unit 13 maintains the increasing or decreasing tendency of the electric current flowing through the Peltier device 16. In other words, in a situation where the electric current flowing through the Peltier device 16 is gradually increased, the control unit 13 maintains the state of gradually increasing the electric current. On the other hand, in a situation where the electric current flowing through the Peltier device 16 is gradually decreased, the control unit 13 maintains the state of gradually decreasing the electric current.

Moreover, if the signal input from the light receiving element 15 at the plurality of timings indicates a decreasing tendency of the optical output level, the control unit 13 makes a change so that the electric current is gradually decreased in a situation where the electric current flowing through the Peltier device 16 is gradually increased. If the signal input from the light receiving element 15 at the plurality of timings indicates a decreasing tendency of the optical output level, the control unit 13 makes a change so that the electric current is gradually increased in a situation where the electric current flowing through the Peltier device 16 is gradually decreased. Further, if the signal input from the light receiving element 15 at the plurality of timings indicates a stable tendency of the optical output level (there is no level change), the control unit 13 controls the electric current flowing through the Peltier device 16 to be maintained. The control unit 13 maintains the state (more specifically, a heating value or an amount of absorbed heat) of the Peltier device 16.

A change in the polarity of the electric current flowing through the Peltier device 16 causes an interchange between the heating condition and the cooling condition. In the heating condition, the degree of heating increases along with an increase in the electric current. In the cooling condition, the degree of cooling increases along with an increase in the electric current.

According to the above control, the temperature of the PLC board is controlled so as to maintain the state where the optical output of the SOA 12 is maximum. Since the electric current injected into the SOA is not changed in order to control the optical output to be maximized, it is possible to achieve a stable operation of a tunable laser without causing an increase in the spectral linewidth.

The above control method of the Peltier device 16 by the control unit 13 is illustrative only. Therefore, any method other than the above control method may be employed as long as the temperature of the PLC board is controlled so as to maintain the state where the optical output of the SOA 12 is maximum.

According to the exemplary embodiment, the optical phase is controlled so as to achieve optimum oscillation characteristics by means of the temperature control of the ring resonator filter 11, without the control in the phase control region of the SOA. Therefore, it is possible to eliminate an increase in the linewidth caused by electric current noise entering the phase control region. Further, the heat capacity of the TLS module is relatively large. Therefore, even if a noise-like disturbance occurs in temperature control in the case of using the temperature control as the phase control, the TLS module functions as an LPF and therefore noise hardly enters the phase control region of the SOA.

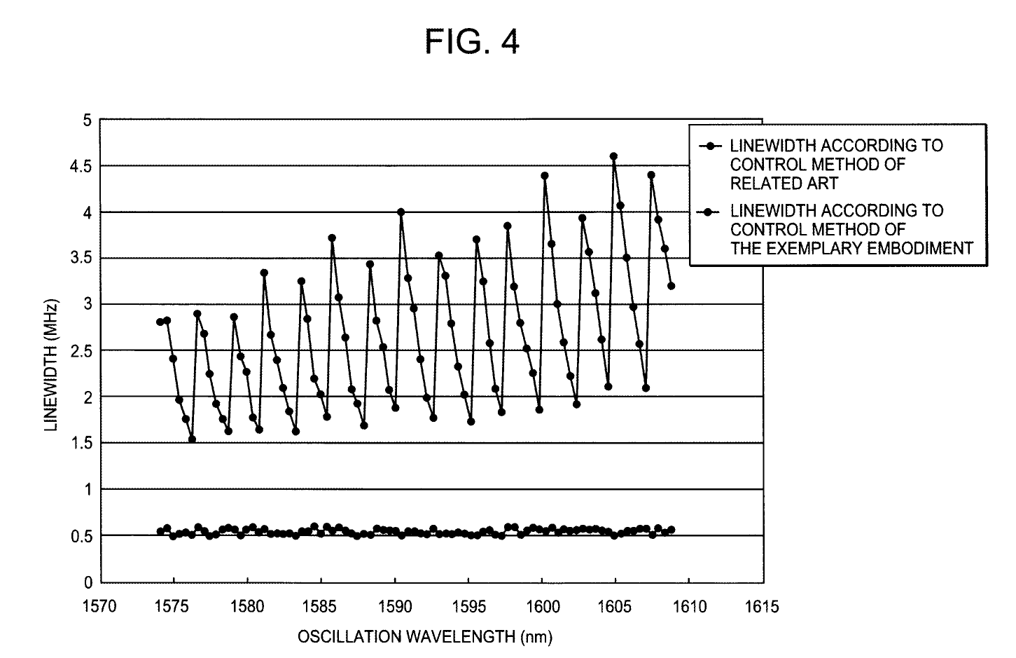

Referring to FIG. 4, there is shown an explanatory diagram illustrating a result of measurements of a linewidth in an optical output from the SOA having the phase control region as shown in FIG. 1 and a linewidth in an optical output from the SOA of this exemplary embodiment. In FIG. 4, the horizontal axis represents the oscillation wavelength of the tunable laser source and the vertical axis represents the linewidth. As shown in FIG. 4, the linewidth ranges from 1.5 to 4.6 MHz if the phase control region of the SOA is controlled, while the linewidth does not depend on the oscillation wavelength, in other words, the linewidth is almost constant at 0.5 MHz independently of the oscillation wavelength in this exemplary embodiment. More specifically, linewidth narrowing is achieved in the tunable laser source of this exemplary embodiment.

### Exemplary Embodiment 2

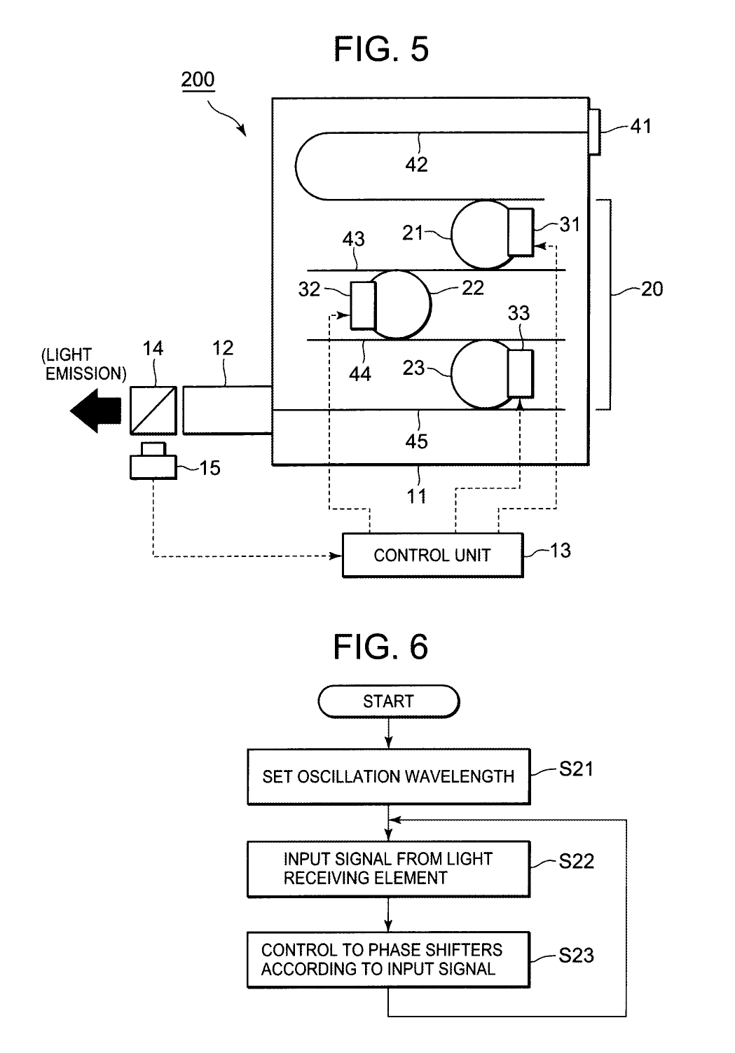

Referring to FIG. 5, there is shown a plan view illustrating a second exemplary embodiment of the tunable laser source according to the present invention. In a tunable laser source 200 shown in FIG. 5, the ring resonator 23 in the multiple optical resonator 20 is provided with a TO phase shifter 33 functioning as a heater.

Although the Peltier device 16 attached to the PLC board 10 is used as a temperature control element in the first exemplary embodiment, the TO phase shifters 31, 32, and 33 are used as temperature control elements in the second exemplary embodiment. In the second exemplary embodiment, unlike the first exemplary embodiment, the control unit 13 controls the electric energy supplied to the TO phase shifters 31, 32, and 33, instead of controlling the Peltier device 16 based on the signal from the light receiving element 15.

Subsequently, referring to FIG. 6, there is shown a flowchart illustrating the operation of the control unit 13 in the second exemplary embodiment. In the second exemplary embodiment, the control unit 13 supplies electric power corresponding to a desired oscillation wavelength to the TO phase shifters 31 and 32 to emit light having a desired wavelength from the tunable laser source 200 (step S21) and receives signal from the light receiving element 15 (step S22). Thereafter, the control unit 13 controls the TO phase shifters 31, 32, and 33 according to the optical output level indicated by the signal from the light receiving element 15 (step S23).

For example, if the signal input from the light receiving element 15 at a plurality of timings indicates an increasing tendency of the optical output level, the control unit 13 maintains the increasing or decreasing tendency of the electric power supplied to the TO phase shifters 31, 32, and 33. In other words, the electric power supplied to each of the TO phase shifters 31, 32 and 33 is gradually increased by the same amount. An increase in the electric power supplied to the TO phase shifters 31, 32 and 33 raises the temperature of the ring resonators 21 and 22. As a result, the temperature of the PLC board 10 rises. If the electric power supplied to each of the TO phase shifters 31, 32 and 33 is decreased by the same amount, the control unit 13 maintains the state of gradually decreasing the electric power. In other words, the control unit 13 maintains differences in heating value between the TO phase shifters, 31, 32, and 33. The control unit 13 is capable of controlling the optimum phase of the light source by carrying out the control as described above.

Moreover, if the signal input from the light receiving element 15 at the plurality of timings indicates a decreasing tendency of the optical output level, the control unit 13 makes a change so that the electric power supplied to the TO phase shifters, 31, 32, and 33 is gradually decreased by the same amount. If the signal input from the light receiving element 15 at the plurality of timings indicates a decreasing tendency of the optical output level and the electric power supplied to the TO phase shifters, 31, 32, and 33 is gradually decreased, the control unit 13 makes a change so that the electric power is gradually increased by the same amount. If the signal input from the light receiving element 15 at the plurality of timings indicates a stable tendency of the optical output level (there is no level change), the control unit 13 controls the electric power supplied to the TO phase shifters, 31, 32, and 33 to be maintained.

In addition, the control unit 13 controls the electric energy supplied to the TO phase shifters, 31, 32, and 33 so as to achieve the same increasing/decreasing amount of electric power to the TO phase shifters, 31, 32, and 33. In other words, when increasing the electric power supplied to the TO phase shifters, 31, 32, and 33, the control unit 13 applies the same increasing amount of electric power to all of the TO phase shifters, 31, 32, and 33. Moreover, when decreasing the electric power supplied to the TO phase shifters, 31, 32, and 33, the control unit 13 applies the same decreasing amount of electric power to all of the TO phase shifters, 31, 32, and 33.

The above method of controlling the electric power supplied to the TO phase shifters, 31, 32, and 33 by the control unit 13 is illustrative only. Therefore, any method other than the above control method may be employed as long as the temperature of the PLC board is controlled so as to maintain the state where the optical output of the SOA 12 is maximum.

As described above, the oscillation mode is optimized by controlling the temperature of the ring resonator filter 11 in the above exemplary embodiments, instead of controlling the phase control region of the SOA. Therefore, it is possible to achieve linewidth narrowing more effectively.

The tunable laser source is generally provided with a temperature control element such as a Peltier device to maintain the temperature constant. Therefore, in the first exemplary embodiment, linewidth narrowing of output light is achieved without any special additional components.

Moreover, while the TO phase shifter 33 is added in the second exemplary embodiment since the TO phase shifters, 31, 32, and 33 are used as temperature control elements, linewidth narrowing of output light is achieved without any other special additional components.

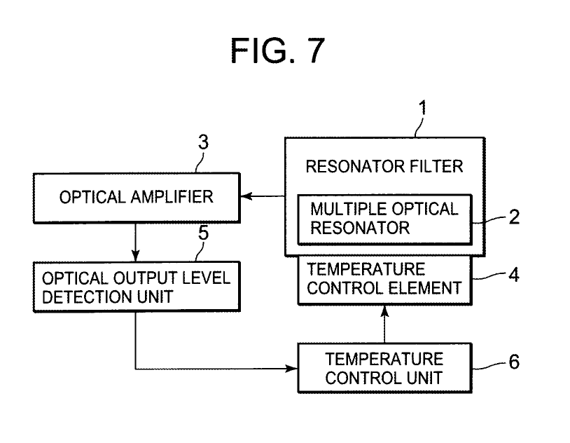

Referring to FIG. 7, there is shown a block diagram illustrating a main part of the tunable laser source according to the present invention. As shown in FIG. 7, the tunable laser source has a resonator filter 1 (corresponding to the ring resonator filter shown in FIG. 2) which includes a multiple optical resonator 2 (corresponding to the multiple optical resonator 20 shown in FIG. 2) having a plurality of optical resonators (corresponding to the ring resonators 21, 22 and 23 shown in FIG. 2) different in optical path length, an optical amplifier 3 (corresponding to the SOA 12 shown in FIG. 2) which amplifies output light from the resonator filter 1, and a temperature control element 4 (corresponding to the Peltier device 16 shown in FIG. 2) provided for the resonator filter 1, and the tunable laser source further includes an optical output level detection unit 5 (corresponding to the light receiving element 15 shown in FIG. 2) which detects an output level of light output from the optical amplifier 3 and a temperature control unit 6 (corresponding to the control unit 13 shown in FIG. 2) which controls the state of the temperature control element 4 so as to maximize the output level detected by the optical output level detection unit 5.

A exemplary effect of the invention is that linewidth narrowing of output light is achieved without any special additional components.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. A tunable laser source comprising a resonator filter which includes a multiple optical resonator including a plurality of optical resonators different in optical path length, an optical amplifier which amplifies output light from the resonator filter, and a temperature control element provided for the resonator filter, the tunable laser source, further comprising
an optical output level detection unit which detects an output level of light output from the optical amplifier; and
a temperature control unit which controls the state of the temperature control element so as to maximize the output level detected by the optical output level detection unit.

2. The tunable laser source according to claim 1, wherein the temperature control element heats or cools the resonator filter.

3. The tunable laser source according to claim 2, wherein the temperature control element is a Peltier device.

4. The tunable laser source according to claim 1, wherein the temperature control element is a wavelength tunable device which changes a resonance wavelength of the multiple optical resonator.

5. The tunable laser source according to claim 4, wherein the temperature control element is a phase shifter which is formed so as to correspond to each of the plurality of optical resonators.

6. The tunable laser source according to claim 1, wherein the optical output level detection unit includes a light ejecting unit for ejecting a part of the light output from the optical amplifier and a light receiving element for outputting a signal corresponding to the output level of the light ejected by the light ejecting unit.

7. A linewidth narrowing method for narrowing a linewidth of optical output emitted from a tunable laser source having a resonator filter which includes a multiple optical resonator having a plurality of optical resonators different in optical path length, an optical amplifier which amplifies output light from the resonator filter, and a temperature control element provided for the resonator filter, the linewidth narrowing method comprising the steps of:
detecting an output level of light output from the optical amplifier; and
controlling the state of the temperature control element so as to maximize the detected output level.

8. The linewidth narrowing method according to claim 7, further comprising the step of controlling electric power supplied to a Peltier device as the temperature control element which heats or cools the resonator filter.

9. The linewidth narrowing method according to claim 7, further comprising the step of controlling electric power supplied to a phase shifter, which is formed so as to correspond to each of the plurality of optical resonators, with the phase shifter as the temperature control element.
